(19) United States
(12) Patent Application Publication
(10) Pub. No.: US 2021/0196073 A1
(43) Pub. Date: Jul. 1, 2021

(54) MULTIPURPOSE INDUCTION COOKER

(71) Applicant: SUNGSHIN ENC CO., LTD., Incheon (KR)

(72) Inventor: Weontae HONG, Incheon (KR)

(21) Appl. No.: 17/054,396

(22) PCT Filed: Apr. 27, 2020
(86) PCT No.: PCT/KR2020/005531

§ 371 Date: Nov. 10, 2020

(30) Foreign Application Priority Data
Aug. 16, 2019 (KR) 10-2019-0100650

(51) Int. Cl. A47J 27/00; A47J 36/34; H05B 6/12

(52) U.S. Cl. CPC A47J 27/002; A47J 27/004; H05B 6/12; H05B 6/1236; A47J 36/34

(57) ABSTRACT

Provided is a multipurpose induction cooker, including: an induction heat supply means (10) having a rotary body (11) having a vessel receiving opening (12), a motor support part (13), an induction coil (16), and guide rollers (17) fixed in the vessel receiving opening (12); a support means (20), a pair of vertical supports (22), and an oil dripping container (24); a cooking vessel (30, 30′) configured to be removably received in the vessel receiving opening (12); a vessel lid (40) detachably attached to an upper part of a cooking chamber (31); a cooking angle adjustment means (50, 50′) configured to rotate the rotary body (11) to allow the rotary body (11) to be in a tilted or vertical state; and a vessel driving means (60) configured to transfer power of a reduction motor (61) to a power transfer plate member (65).

### BACKGROUND

The present disclosure relates to a cooker used for cooking food and, more specifically, to a multipurpose induction cooker capable of performing various kinds of cooking such as roasting, boiling, steaming, frying, and the like.

As prior art, a drum type cooker is disclosed in Korean Patent No. 10-1331289 and Korean Patent No. 10-1640493.

However, since such priority art allows a cooking vessel to perform cooking only in a tilted state, there is a problem that only limited cooking, such as frying rice and roasting meat, can be performed.

In addition, since the cooking vessel is configured to perform only the cooking described above, the cooking vessel is not significantly heavy after food is inserted thereinto so that a power transfer structure for transferring power of a motor to the cooking vessel is simple. Accordingly, when the cooking vessel having food filled therein is heavy, overwork or load is applied to the power transfer structure as well as the motor so the cooking vessel fails or cannot be used as a multipurpose cooker.

### SUMMARY OF THE INVENTION

An objective of the present disclosure is to provide a multipurpose induction cooker capable of performing various kinds of cooking such as roasting, boiling, steaming, frying, and the like.

Another objective of the present disclosure is to provide a multipurpose induction cooker capable of being used with adjustment for tilting and erecting a cooking vessel in accordance with a kind of cooking.

Still another objective of the present disclosure is to provide a multipurpose induction cooker configured to efficiently transfer power of a motor to a cooking vessel even though the cooking vessel is heavy due to food contained therein and to have a strong power transfer structure, so that the breakage of the cooker does not occur and reliability of a product is significantly enhanced.

The present disclosure is characterized in that a multipurpose induction cooker may include: an induction heat supply means including a rotary body having a vessel receiving opening formed therein, an L-shape motor support part extended from a lower part of the rotary body, an induction coil mounted inside the rotary body, and a plurality of guide rollers rotatably disposed on respective roller shafts that are fixed on the inner circumferential surface of the vessel receiving opening at four positions, respectively; a support means including a bottom weight part for supporting the rotary body, a pair of vertical supports disposed on opposite sides of the bottom weight part, respectively, and having rotation center shafts fixed therein to be inserted into body shaft holes formed on opposite sides of the rotary body, respectively, and an oil dripping container detachably attached to an oil dripping container receiving groove formed on one side of the bottom weight part; a cooking vessel configured to be removably received in the vessel receiving opening of the rotary body, having a cooking chamber formed therein, and having an oil dripping hole formed on one side of a bottom part of the cooking chamber; a vessel lid detachably attached to an upper part of the cooking chamber of the cooking vessel and having a handle formed therein; a cooking angle adjustment means configured to rotate the rotary body supported to the pair of vertical supports to allow the rotary body to be in a tilted or vertical state; and a vessel driving means configured to transfer power of a reduction motor, which is mounted on the motor support part and is operated by a command of a controller, to a power transfer plate member locked to a central groove part formed at the center of the bottom part of the cooking vessel.

The present disclosure is further characterized in that one or more long protruding turner rim parts may longitudinally protrude from the inner circumferential surface of the cooking vessel while being integrally formed with the cooking vessel.

The present disclosure is further characterized in that the cooking angle adjustment means may include: a left locking protrusion and a right locking protrusion formed on opposite sides of a lower part of the body shaft hole of the rotary body; an operation button inserted into a button moving groove, which is formed on an outer surface of the vertical support including the rotation center shafts inserted into the body shaft holes, to move in a vertical direction; a coupler penetration groove communicating with a button moving hole and formed on a lower part of the rotation center shaft; a vertical moving device configured to be inserted into the coupler penetration groove to move in a vertical direction, the vertical moving device having an receiving groove formed on an upper part, and a spring rod formed on a lower part, and configured to be connected to an operation button by a coupler penetrating the coupler penetration groove; an elastic member allowing the spring rod to pass through to supply elasticity in an upper direction of the vertical moving device; and a left stopping protrusion and a right stopping protrusion formed on an outer circumferential surface of the rotation center shaft.

The present disclosure is further characterized in that the cooking angle adjustment means may be configured to allow a plurality of inverted triangular protrusions, which protrude at equal intervals from an outer circumferential surface of a power transfer plate fixed to a motor shaft of a normal and reverse rotation reduction motor disposed inside the vertical support facing the body shaft hole, to be matched with and coupled to a plurality of inverted triangular power transfer holes formed on an outer circumference of the body shaft hole of the rotary body.

The present disclosure is further characterized in that the vessel driving means may include: a center protrusion and a plurality of rotary protrusions, which protrude from the outside of the center protrusion at equal intervals, of a power transfer member rotated by the power of the reduction motor; and a center hole and a plurality of locking slots, which are formed on the outside of the center hole and are configured to allow the rotary protrusions to pass through, of a power transfer plate member that comes in surface contact with the power transfer member and is locked to the circumference of the center groove part of the bottom part of the cooking vessel.

The present disclosure is further characterized in that the multipurpose induction cooker may further include a lid receiving means that includes a vessel handle disposed on each of opposite sides of an upper part of the cooking vessel, a slide groove formed in the vessel handle in a central direction of the cooking vessel and having separation preventing grooves formed on opposite sides thereof, and a lid coupler configured to be inserted into the slide groove to move in a longitudinal direction and having separation preventing protrusions formed on opposite sides thereof to be inserted into the slide grooves, wherein a ball receiving elasticity of a spring, which is inserted into a spring groove formed on a lower part of the middle part of the slide groove, is inserted into a ball pressing groove formed on a lower part of the lid coupler to be pressed to the lid coupler.

Since the multipurpose induction cooker of the present disclosure includes the cooking angle adjustment means, the cooking vessel can be used with adjustment for tilting and erecting the cooking vessel in accordance with a kind of cooking, thereby providing an effect capable of performing various kinds of cooking such as roasting, boiling, rice cooking, steaming, frying, and the like.

In addition, since the power of the reduction motor configured to rotate the cooking vessel is transferred in a circumferential type without being concentrated on the bottom part of the cooking vessel, the cooking vessel is rotated well even though food filled in the cooking vessel is heavy, thereby providing effect capable of cooking heavy food, such as cooked rice, braised short ribs, and the like.

Moreover, even though the cooking vessel is heavy due to food contained therein, the power of the motor is transferred to the cooking vessel well and a strong power transfer structure is provided, thereby providing effects of preventing a breakage of the cooker and significantly enhancing reliability of a product.

### BRIEF DESCRIPTION OF DRAWINGS

FIG. 1 is an exploded perspective view of a multipurpose induction cooker according to the present disclosure.

FIG. 2 is a side sectional view showing an entire configuration of a multipurpose induction cooker of the present disclosure.

FIG. 3 is a side sectional view of a multipurpose induction cooker of the present disclosure.

FIG. 4 is a perspective view of an induction heat supply means and a support means of the present disclosure.

FIG. 5 is a plan view showing a state in which a guide roller of the present disclosure is applied.

FIGS. 6(a) and 6(b) are plan views showing cooking vessels applied to the present disclosure.

FIG. 7 is an exploded perspective view showing a cooking angle adjustment means and a cooking angle of an embodiment of the present disclosure.

FIG. 8 is an exploded perspective view showing a cooking angle adjustment means of an embodiment of the present disclosure.

FIG. 9 is a perspective view showing a part of a configuration of a cooking angle adjustment means of an embodiment of the present disclosure.

FIG. 10 is a side sectional view showing a configuration of a cooking angle adjustment means of an embodiment of the present disclosure.

FIGS. 11(a) and 11(b) are side sectional views of a multipurpose induction cooker showing a state in which the cooking angle is adjusted by a cooking angle adjustment means of an embodiment of the present disclosure.

FIG. 12 is a side sectional view showing operation of a cooking angle adjustment means of an embodiment in a state in which the cooking angle of a rotary body of the present disclosure is adjusted to a tilted state.

FIG. 13 is a view showing operation of the main part of FIG. 12.

FIG. 14 is a side sectional view showing operation of a cooking angle adjustment means of an embodiment in a state in which the cooking angle of a rotary body of the present disclosure is adjusted to a vertical state.

FIG. 15 is a view showing operation of the main part of FIG. 14.

FIG. 16 is a side sectional view showing a configuration of a cooking angle adjustment means according to another embodiment of the present disclosure.

FIG. 17 is an exploded perspective view of the main part of a cooking angle adjustment means of the embodiment of the present disclosure.

FIGS. 18(a) and 18(b) are perspective views showing parts of a vessel driving means of the present disclosure.

FIG. 19 is an exploded sectional view showing a lid receiving means of the present disclosure.

FIG. 20 is a sectional view showing a lid receiving means of the present disclosure.

FIG. 21 is a sectional view showing a configuration of the lid receiving means taken along the line Y-Y′ of FIG. 20.

### DETAILED DESCRIPTION OF THE INVENTION

The present disclosure provides a multipurpose induction cooker including: an induction heat supply means including a rotary body having a vessel receiving opening formed therein, an L-shape motor support part extended from a lower part of the rotary body, an induction coil mounted inside the rotary body, and a plurality of guide rollers rotatably disposed on respective roller shafts that are fixed on the inner circumferential surface of the vessel receiving opening at four positions, respectively; a support means including a bottom weight part for supporting the rotary body, a pair of vertical supports disposed on opposite sides of the bottom weight part, respectively, and having rotation center shafts disposed therein to be inserted into body shaft holes formed on opposite sides of the rotary body, respectively, and an oil dripping container detachably attached to an oil dripping container receiving groove formed on one side of the bottom weight part; a cooking vessel configured to be removably received in the vessel receiving opening of the rotary body, having a cooking chamber formed therein, and having an oil dripping hole formed on one side of a bottom part of the cooking chamber; a vessel lid detachably attached to an upper part of the cooking chamber of the cooking vessel and having a handle formed therein; a cooking angle adjustment means configured to rotate the rotary body supported to the pair of vertical supports to allow the rotary body to be in a tilted or vertical state; and a vessel driving means configured to transfer power of a reduction motor, which is mounted on the motor support part and is operated by a command of a controller, to a power transfer plate member locked to a central groove part formed at the center of the bottom part of the cooking vessel.

Hereinafter, with reference to the contents described in the accompanying drawings, the present disclosure will be described in detail.

Largely divided, the present disclosure may include: an induction heat supply means 10; a support means 20 supporting the induction heat supply means 10; a cooking vessel 30, 30′ inserted into a vessel receiving opening 12 of the induction heat supply means 10 to contain food to be cooked therein; a cooking angle adjustment means 50, 50′ configured to rotate a rotary body 11 of the induction heat supply means 10 to be in a tilted or vertical state in accordance with a kind of cooking; a vessel lid 40 of the cooking vessel 30, 30′; and a lid receiving means 70 to detachably attach the vessel lid 40 to the cooking vessel 30, 30′.

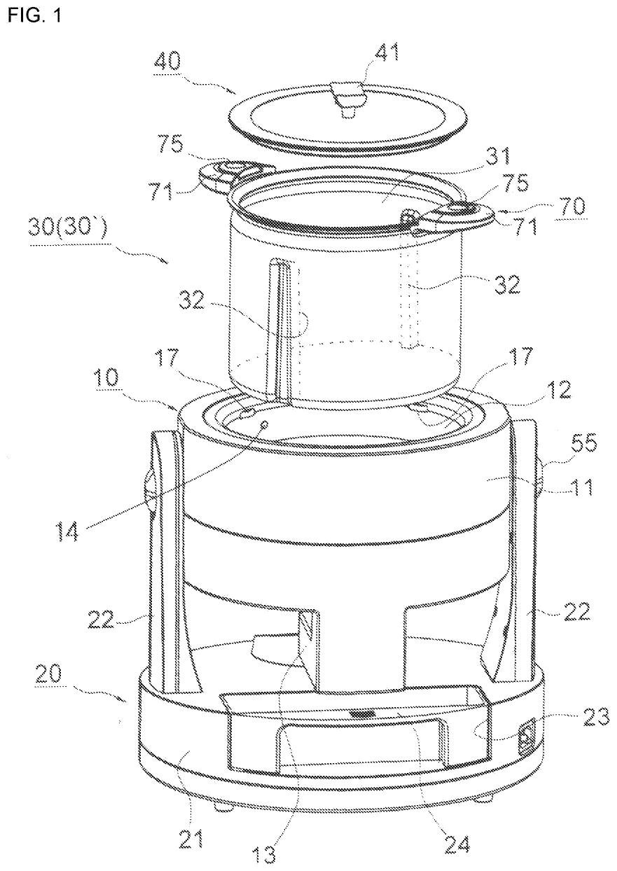

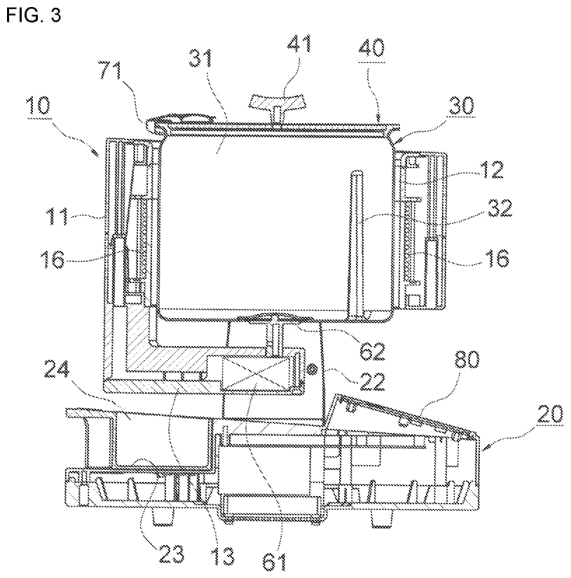

As shown in FIGS. 1, 2, and 3, the induction heat supply means 10 may include: the rotary body 11 having the vessel receiving opening 12 formed therein; and an L-shape motor support part 13 extended from a lower part of the rotary body 11.

In addition, the rotary body 11 has an induction coil 16 disposed therein. As current is supplied to the induction coil 16, magnetic field lines are generated in the wound induction coil 16 and eddy currents are generated by a resistant component (iron component), which is the major material of the cooking vessel 30, 30′, and when the magnetic force lines pass through the induction coil 16, the food contained in the cooking vessel 30, 30′ is heated. However, it is well known as technology applied to an induction oven and the like, so detail drawings and descriptions are omitted.

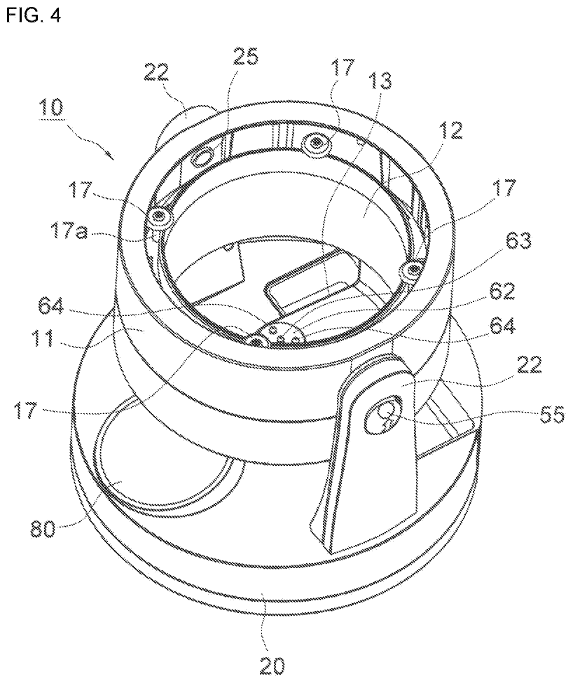

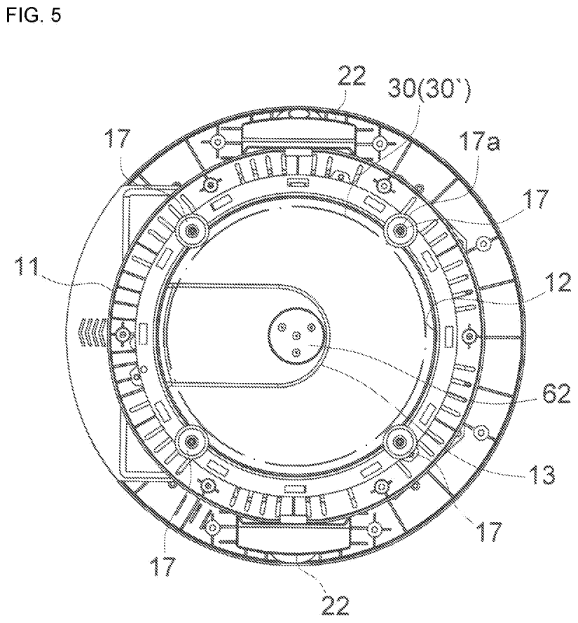

As shown in FIGS. 4 and 5, the induction heat supply means 10 may include a plurality of guide rollers 17 fixed on an inner circumferential surface of the vessel receiving opening 12 at four positions, respectively.

Accordingly, an outer circumferential surface of an upper end part of the cooking vessel 30, 30′ inserted into the vessel receiving opening 12 comes in contact with the guide rollers so that the cooking vessel 30, 30′ is rotated, thereby being stably rotated.

In addition, as shown in FIG. 1, since an overheat sensor 14 is disposed on an inner circumferential surface of the vessel receiving opening 12, it is detected that temperature is higher than a cooking temperature set for cooking and a detection result is applied to a controller 80 so that the controller 80 automatically cuts off the current supplied to the induction coil 16.

As shown in FIGS. 1 to 4, the support means 20 may include: a bottom weight part 21 for supporting the rotary body 11; a pair of vertical supports 22 disposed on opposite sides of the bottom weight part 21, respectively, and having rotation center shafts 25, 59 disposed therein to be inserted into body shaft holes 26, 51 formed on opposite sides of the rotary body 11, respectively; and an oil dripping container 24 detachably attached to an oil dripping container receiving groove 23 formed on one side of the bottom weight part 21.

Accordingly, the rotary body 11 is configured to rotate around the rotation center shafts 25, 59 and the controller 80 is disposed on one side of the bottom weight part 21. The controller 80 stores heating temperature, heating time, and the like in accordance with a kind of cooking, and controls the induction coil 16 and a forward and reverse rotation motor 50, a reduction motor 61, and the like to be described later. However, since such a control circuit is well known, detailed drawings and descriptions are omitted.

The cooking vessel 30, 30′ is configured to be rotated by the vessel driving means 60 while being inserted into the vessel receiving opening 12 of the rotary body 11 and may include vessel handles 71 formed on opposite sides of an upper end part thereof, respectively.

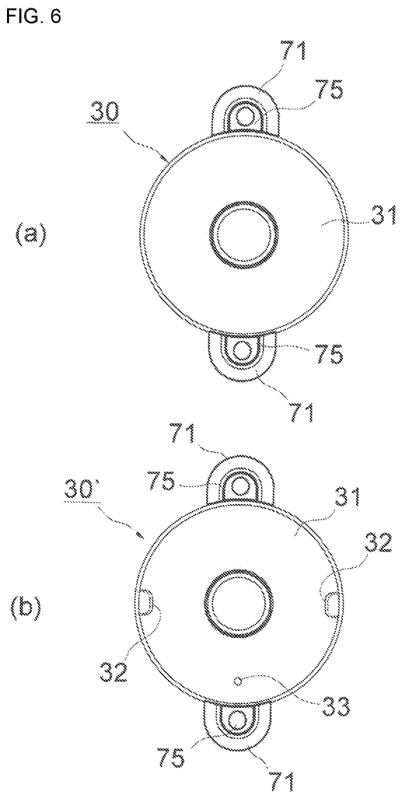

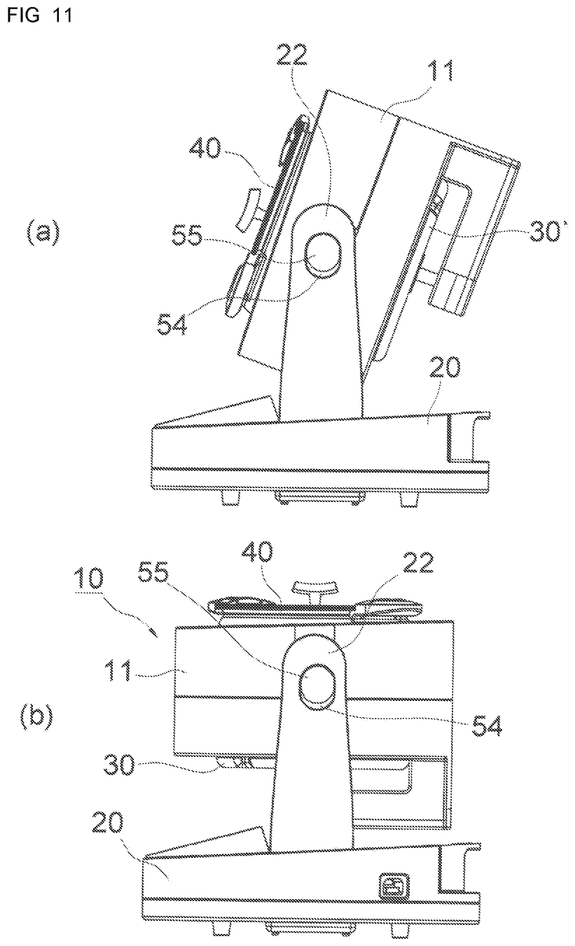

In addition, as shown in FIG. 6(a), provided is a cooking vessel 30 having only a cooking chamber 31 into which food is inserted. The cooking vessel 30 is mainly used in a state in which the rotary body 11 is vertically installed as shown in FIG. 11(b) and in this case, is used for rice cooking and steaming.

On the other hand, as shown in FIG. 6(b), the cooking vessel 30′, which may include one or more long protruding turner rim parts 32 longitudinally protruding from the inner circumferential surface of the cooking vessel 30′ and an oil dripping hole 33 formed on one side of a bottom part 34 of the cooking chamber 31, may be used.

Such a cooking vessel 30′ is mainly used when performing cooking in a state in which the rotary body 11 is rotated while being tilted in a tilted direction as shown in FIG. 11(a). In this case, the cooking vessel 30′ is mainly used for cooking fried rice or roasting meat or fish, and oil coming out from food cooked in the cooking chamber 31 during cooking automatically flows down to an oil dripping container 24 disposed on a lower side thereof to be stored in the oil dripping container 24.

In addition, when the cooking vessel 30′ is rotated by power of the reduction motor 61 of the vessel driving means 60, the food is closely attached to the inner circumferential surface of the cooking chamber 31 to be rotated with the cooking chamber 31. At this time, due to the protruding tuner rim parts 32 protruding toward the inside of the cooking chamber 31, which are the inside of the cooking vessel 30′, the food is prevented from being rotated to be separated from the cooking chamber 31 and falling onto a lower part of the cooking chamber 31 by a pair of protruding turner rim parts 32, such that the food is turned over, thereby being uniformly cooked.

Moreover, since such a protruding turner rim part 32 performing a function of turning the food is formed by pressing an outer circumferential surface of the cooking vessel 30′ made of metal with a press mold to allow the outer circumferential surface to protrude toward the inside of the cooking chamber 31, the protruding turner rim parts 32 are integrally formed with the cooking vessel 30′ to be prevented from being separated from the cooking vessel 30′ and be reinforced, thereby increasing reliability of a product.

Moreover, the multipurpose induction cooker of the present disclosure may include the vessel lid 40 detachably attached to an upper part of the cooking chamber (31) of the cooking vessel 30, 30′ and having the handle 41 formed therein.

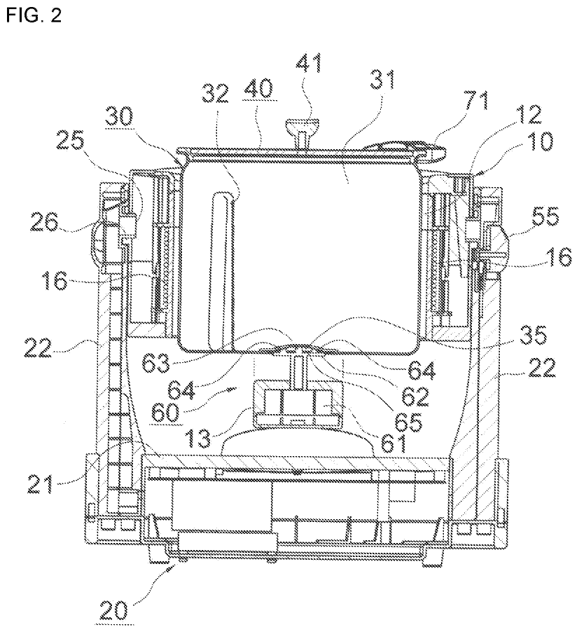

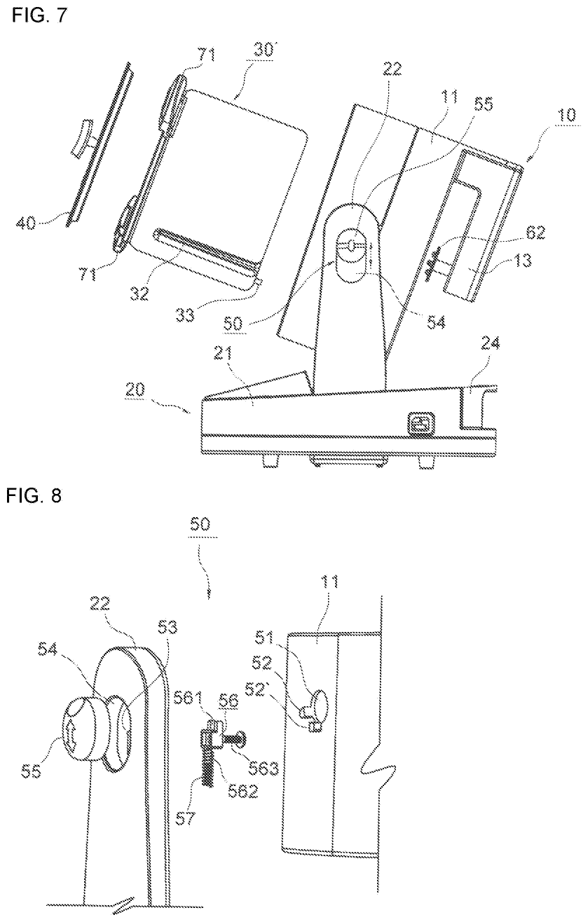

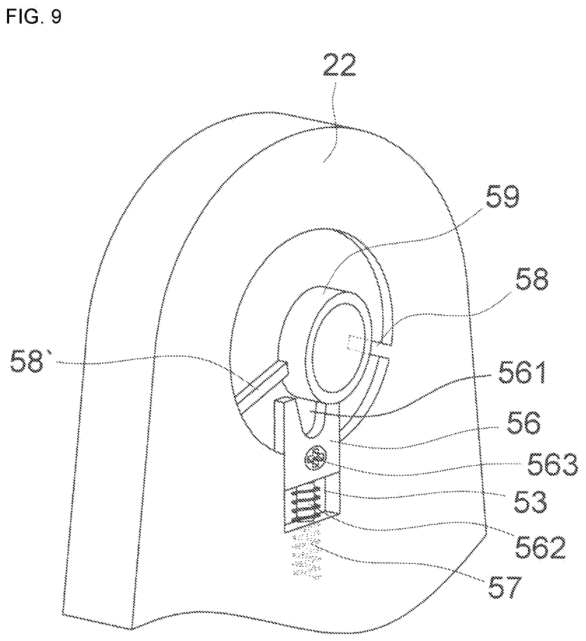

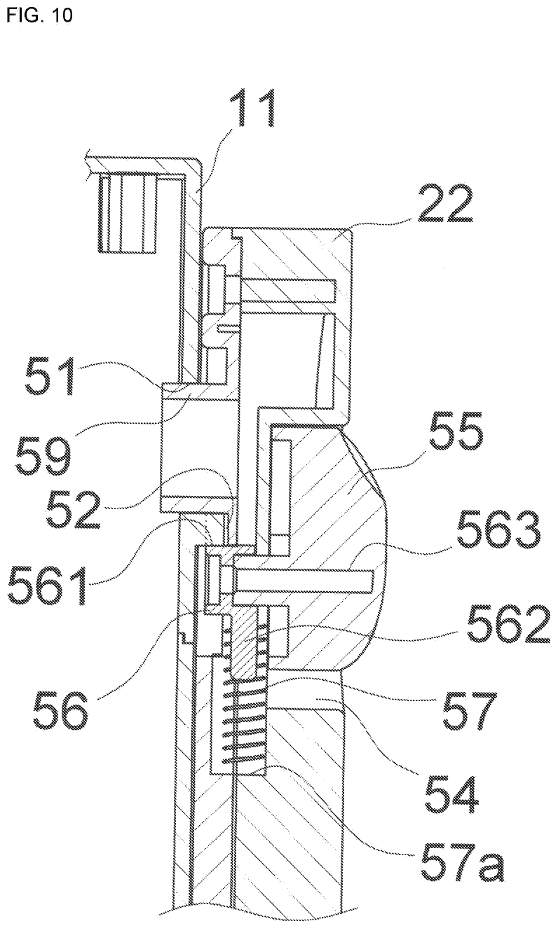

On the other hand, the multipurpose induction cooker of the present disclosure may include the cooking angle adjustment means 50 that allows the rotary body 11 to perform cooking in a vertically state as shown in FIGS. 1 and 2 or perform cooking while rotating in the tilted direction as shown in FIG. 7. FIGS. 7 to 14 show the cooking angle adjustment means 50 of an embodiment in which an operation button 55 disposed on an outer surface of a side vertical support 12 is operated so that the rotary body 11 is rotated.

With reference to FIGS. 8, 9, and 10, the angle adjustment means 50 may include a left locking protrusion 52 and a right locking protrusion 52′ formed on opposite sides of a lower part of the body shaft hole 51 of the rotary body 11, respectively.

In addition, the angle adjustment means 50 may include the operation button 55 inserted into a button moving hole 54, which is formed on the outer surface of the vertical support 22 including the rotation center shaft 59 inserted into the body shaft hole 51, to move in a vertical direction.

In addition, the angle adjustment means 50 may include: a coupler penetration groove 53 communicating with the button moving hole 54 and formed on a lower part of the rotation center shaft 59; and a vertical moving device 56 configured to be inserted into the coupler penetration groove 53 to move in a vertical direction, the vertical moving device 56 having an receiving groove 561 formed on an upper part, and a spring rod 562 formed on a lower part, and configured to be connected to the operation button 55 by a coupler 563 penetrating the coupler penetration groove 53.

Accordingly, when the operation button 55 is forcibly moved downwards by force of fingers, the vertical moving device 56 connected to the coupler 563 moves downwards. When the downward force of fingers applied to the operation button 55 is removed, the vertical moving device 56 moves upwards by elasticity of an elastic member 57 so that the vertical moving device 56 connected by the coupler 563 automatically moves upwards.

Moreover, the angle adjustment means 50 may include: the elastic member 57 allowing a spring rod 562 to pass through to supply elasticity in an upper direction of the vertical moving device 56; and a left stopping protrusion 58 and a right stopping protrusion 58′ formed on an outer circumferential surface of the rotation center shaft 59.

Accordingly, to rotate the rotary body 11 from a tilted state as shown in FIG. 11(a) to a vertical state as show in FIG. 11(b), when the operation button 55 is moved downwards and the force for moving the operation button 55 downwards is removed in a state in which the operate button 55 is rotated to allow the rotary body to be adjusted in a vertical direction, the operation button 55 automatically moves upwards so that the rotary body 11 is prevented from rotating again in the tilted direction.

On the contrary, to rotate the rotary body 11 from the vertical state as shown in FIG. 11(b) to the tilted state as shown in FIG. 11(a), when the operation button 55 is also moved downwards and the force for moving the operation button 55 downwards is removed in a state in which the operate button 55 is rotated to allow the rotary body to be adjusted in the vertical direction, the operation button 55 automatically moves upwards so that the rotary body 11 is prevented from rotating again in the vertical direction and such a configuration will be described in detail.

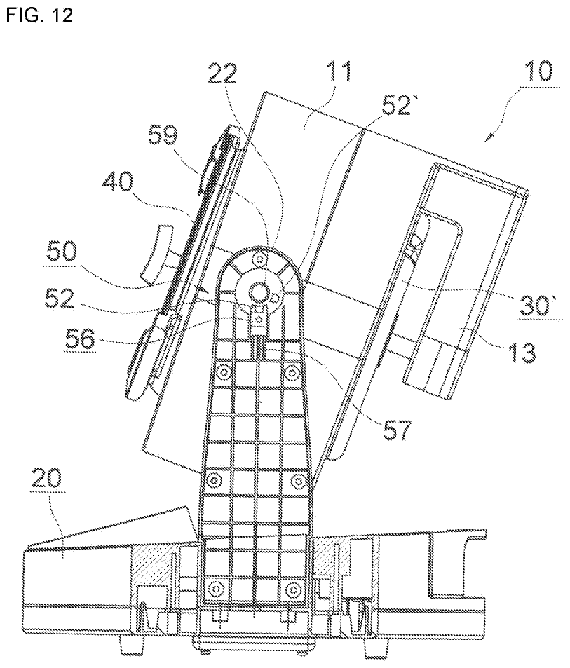

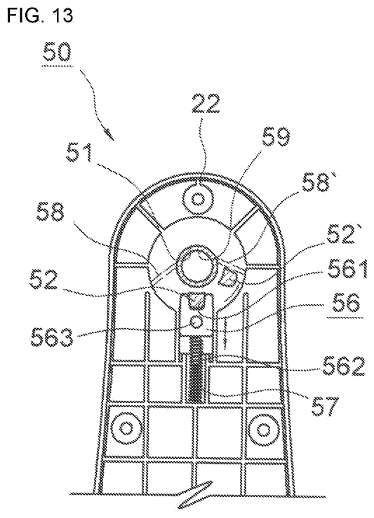

FIG. 12 shows the tilted state of the rotary body 11. In this case, as shown in FIG. 13, the vertical moving device 56 is always in a state of being moved upwards by the elasticity of the elastic member 57. In this state, the left locking protrusion 52 is inserted into the receiving groove 561 so that the rotary body 11 cannot be rotated and the right locking protrusion 52′ comes in contact with the right stopping protrusion 58′ to prevent the rotary body 11 from rotating in an anticlockwise direction any more in FIG. 12.

Accordingly, when the operation button 55 is forcibly moved downwards by manual operation in a state like FIG. 13 in which the rotary body 11 is locked in the tilted state, the vertical moving device 52 moves downwards so that the left locking protrusion 52 is separated from the receiving groove 561 to be in a free state and thus the rotary body 11 may be turned by hand. At this time, the left locking protrusion 52 and the right locking protrusion 52′ are simultaneously rotated in a clockwise direction.

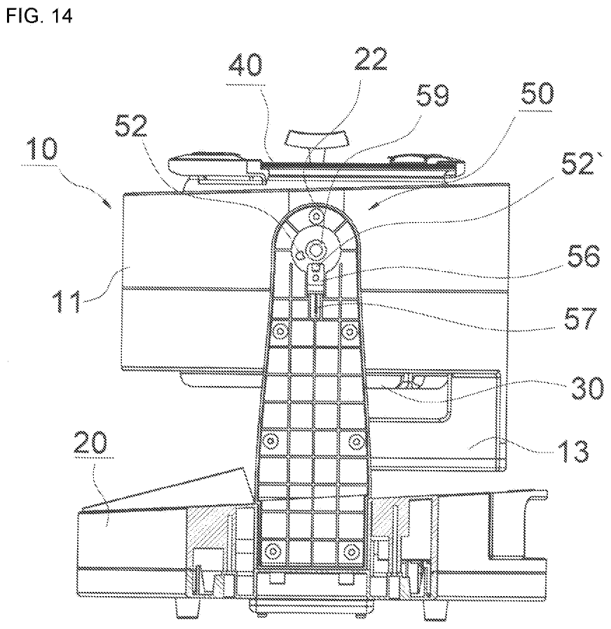

At this time, the rotary body 11 is rotated in the clockwise direction as shown in FIG. 12 to be locked in the vertical state as shown in FIG. 14. At this time, as shown in FIG. 14, the left locking protrusion 52 is also rotated in the clockwise direction to be locked to the left stopping protrusion 58 so that the rotary body 11 is prevented from rotating in the clockwise direction any more to be locked in a stopped state.

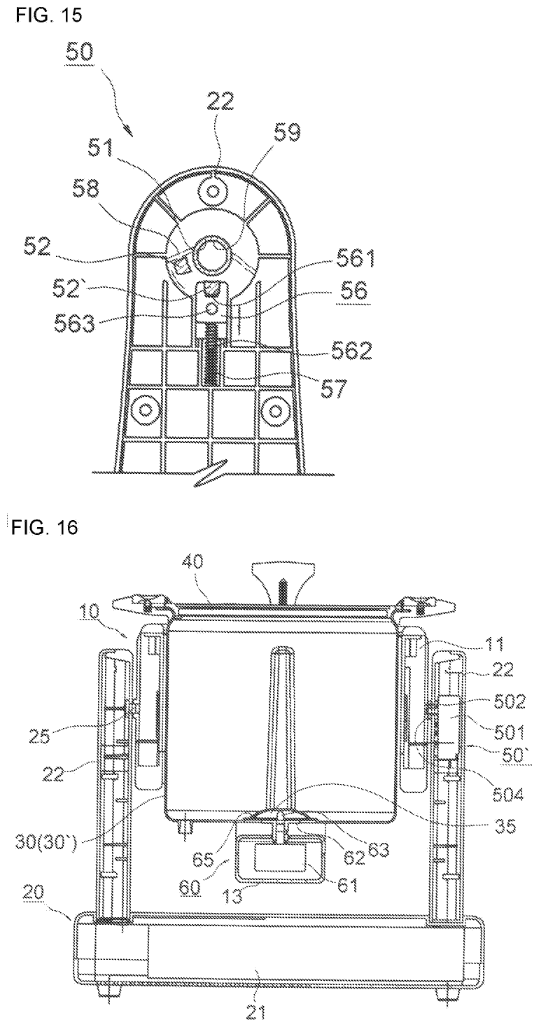

Accordingly, as described above, if hand force (external force) moving the operation button 55 downwards is removed when the rotary body 11 is not rotated in the clockwise direction to be in the stopped state, the vertical moving device 56 moves upwards by the elasticity of the elastic member 57 as shown in FIG. 15 so that the right locking protrusion 52′ is inserted into the receiving groove 561 and thus the rotary body 11 is prevented from rotating any more to maintain a vertically stopped state.

In addition, to rotate the rotary body 11 from the vertical state as shown in FIG. 14 to the tilted state as show in FIG. 12, when the operation button 55 is forcibly moved downwards by manual operation in a state as shown in FIG. 15, the vertical moving device 56 moves downwards so that the right locking protrusion 52′ is separated from the receiving groove 561 to be in a free state and thus the rotary body 11 may be rotated by hand. At this time, the left locking protrusion 52 and the right locking protrusion 52′ are simultaneously rotated in the clockwise direction.

Accordingly, the rotary body 11 is rotated in the anticlockwise direction in a state as shown in FIG. 14 to be locked in the tilted state as show in FIG. 12. At this time, as shown in FIG. 13, the right locking protrusion 52′ is also rotated in the clockwise direction to be locked in the right stopping protrusion 58′ and thus the rotary body 11 is prevented from rotating in the anticlockwise direction any more to be locked in the stopped state.

Accordingly, as described above, if the hand force (external force) moving the operation button 55 downwards is removed when the rotary body 11 is prevented from rotating in the anticlockwise direction to be locked in the stopped state, the vertical moving device 56 moves upwards by the elasticity of the elastic member 57 as shown in FIG. 13 so that the right locking protrusion 52 is inserted into the receiving groove 561 and thus the rotary body 11 is prevented from rotating any more to maintain a tilted stopped state.

In other words, when the hand force applied to the operation button 55 is removed after the rotary body 11 is rotated in the tilted direction or the vertical direction in the state in which the operation button 55 moves downwards, the operation button 55 automatically moves upwards and thus the moving body 11 may be simply adjusted to an angle (hereinafter, referred to as a cooking angle) for cooking, such as the tilted angle as shown in FIG. 11(a) and the vertical angle as shown in FIG. 11(b).

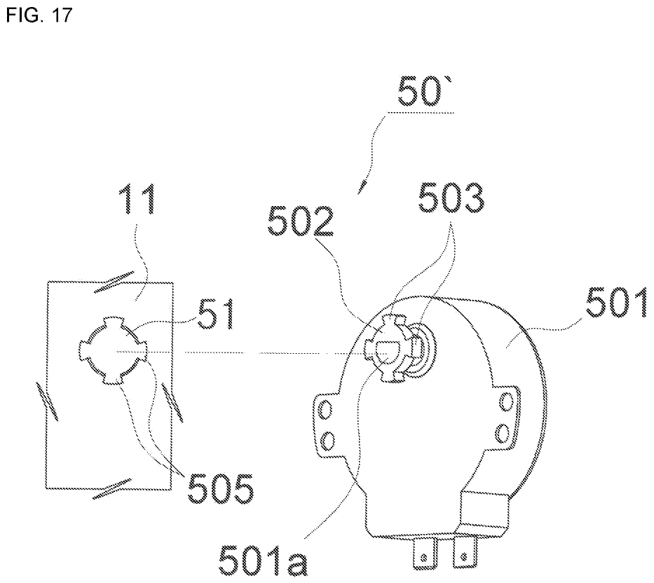

FIGS. 16 and 17 show a cooking angle adjustment means 50′ of another embodiment of the present disclosure and the cooking angle adjustment means 50′ is configured to allow a plurality of inverted triangular protrusions 503, which protrude at equal intervals from an outer circumferential surface of a power transfer plate 502 fixed to a motor shaft 501a of a forward and reverse rotation reduction motor 501 disposed inside the vertical support 22 facing the body shaft hole 51, to be matched with and coupled to a plurality of inverted triangular power transfer holes 505 formed on an outer circumference of the body shaft hole 51 of the rotary body 11.

Accordingly, when the controller 80 is operated and the forward and reverse rotation reduction motor 501 rotates in a normal direction by a command of the controller 80, the cooking angle adjustment means 50′ is stopped after the rotary body 11 is rotated to the vertical state. On the contrary, when the forward and reverse rotation reduction motor 501 rotates in a reverse direction, the cooking angle adjustment means 50′ is stopped after the rotary body 11 is rotated to the tilted state. However, since such a control circuit of the controller 80 is well known, detailed drawings and descriptions are omitted.

Accordingly, since the cooking angle adjustment means 50′ is operated by matching and coupling the inverted triangular protrusions 503 of the power transfer plate 502 with and to the plurality of inverted triangular power transfer holes 505 formed on the outer circumference of the body shaft hole 51, driving force of the forward and reverse rotation reduction motor 501 is sufficiently transferred due to a wide transfer area and thus a breakage of the cooker does not occur and the rotary body 11 may be simply adjusted to the cooking angle such as the tilted angle as shown in FIG. 11(a) and the vertical angle as shown in FIG. 11(b).

On the other hand, the multipurpose induction cooker of the present disclosure may include the vessel driving means 60 for rotating the cooking vessel 30, 30′ inserted into the vessel receiving opening 12 of the rotary body 11 that rotates in the tilted state or the vertical state as described above.

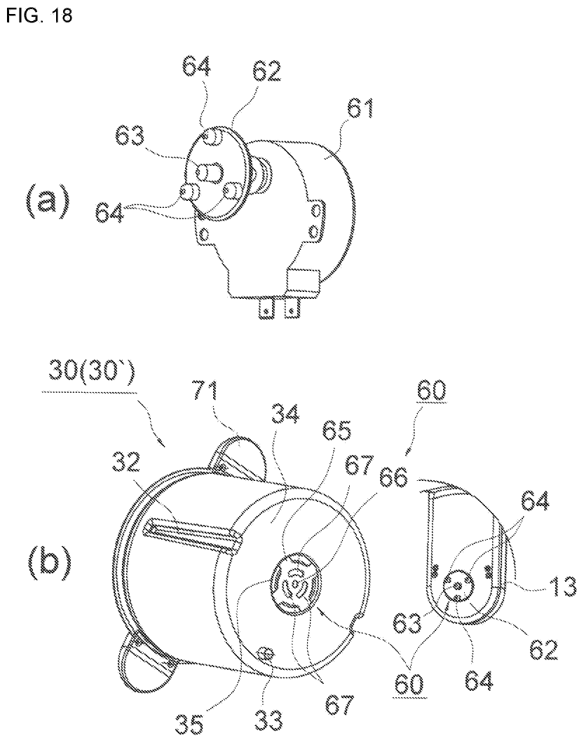

With reference to FIGS. 2, 3, and 18, the vessel driving means 60 may include: a center protrusion 63 of the power transfer member 62 configured to be rotated by the power of the reduction motor 61; the plurality of rotary protrusions 64 protruding on the outside of the center protrusion 63 at equal intervals; a center hole 66 of a power transfer plate member 65 configured to come in surface contact with the power transfer member 62 and be locked to the circumference of the center groove part 35 of the bottom part 34 of the cooking vessel 30, 30′; and the plurality of locking slots 67 famed on the outside of the center hole 66 and configured to allow the rotary protrusions 64 to be inserted thereinto, respectively.

Accordingly, when the cooking vessel 30, 30′ is inserted into the vessel receiving opening 12 of the rotary body 11, the rotary protrusions 64 are inserted into the plurality of locking slots 67, respectively, as the center protrusion 63 is inserted into the center hole 66, so that the two members 62, 65 naturally come in contact with each other, thereby simply forming a power transferable state.

In addition, since the plurality of rotary protrusions 64 are rotated, the power is transferred through a wider area than that of an existing product, in which the power is transferred by only one shaft, and thus the cooking vessel 30, 30′ that becomes a relatively heavy due to food contained therein may be rotated with a sufficient force by only the small power of the reduction motor.

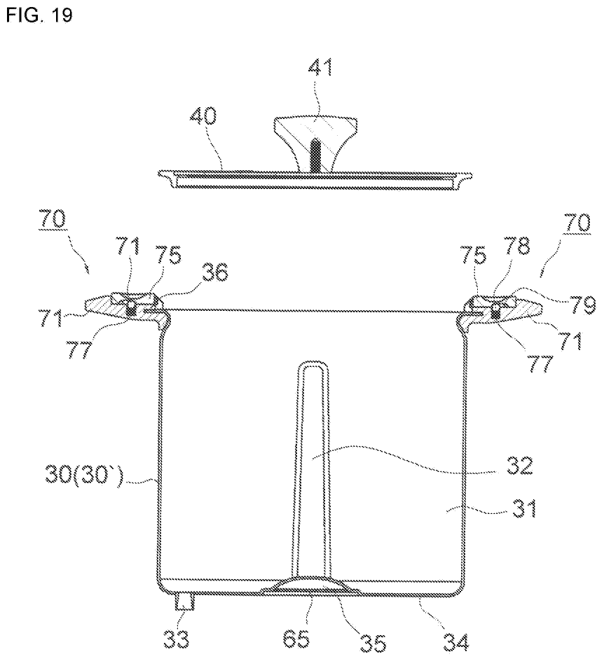

FIGS. 19, 20, and 21 show the lid receiving means 70 according to the present disclosure may include: a vessel handle 71 disposed on each of opposite sides of the upper part of the cooking vessel 30, 30′; and a slide groove 73 formed in the vessel handle 71 in the central direction of the cooking vessel 30, 30′ and having separation preventing grooves 72 formed on opposite sides thereof.

In addition, the lid receiving means 70 may further include a lid coupler 75 configured to be inserted into the slide groove 73 to move in the longitudinal direction and having separation preventing protrusions 74 formed on opposite sides thereof to be inserted into the slide grooves 73, respectively.

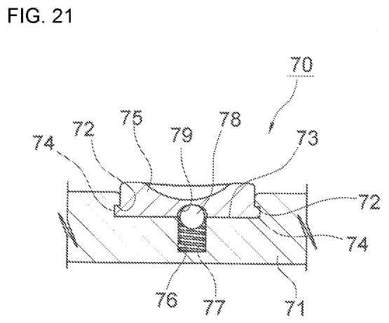

Accordingly, as shown in FIG. 21, the separation preventing protrusions 74 are locked in the separation preventing grooves 72, respectively, the lid coupler 75 may move in a longitudinal direction without being separated in an upper direction.

In addition, the lid receiving means 70 may be configured to allow a ball 78 receiving elasticity of the spring 77, which is inserted into the spring groove 76 formed on the lower part of the middle part of the slide groove 73, to be inserted into the ball pressing groove 79 formed on the lower part of the lid coupler 75 to press the ball 78 to the lid coupler 75. 75a denotes a finger groove part.

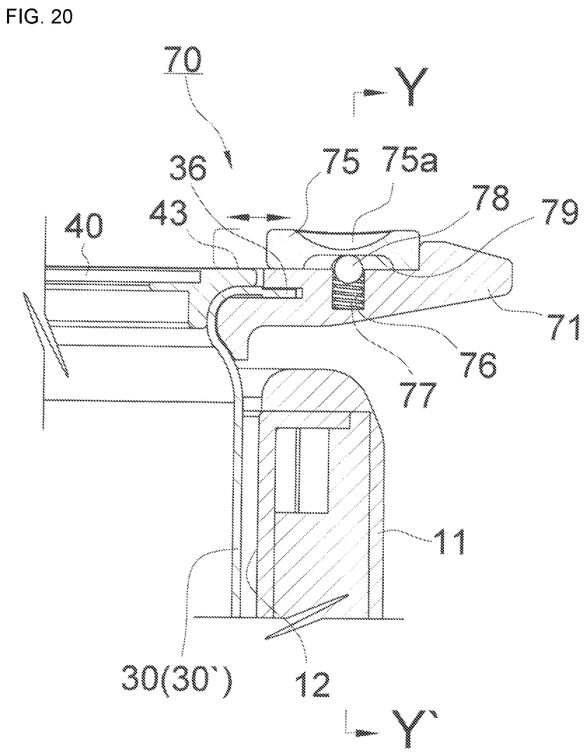

Accordingly, as shown by a solid line in FIG. 20, when the lid coupler 75 is placed in an external direction (right side in drawing), the vessel lid 40 is attached to an upper part of the cooking chamber 31 of the cooking vessel 30, 30′ so that the cooking chamber 31 is sealed. In such a state, when the lid coupler 75 moves in an internal direction (left side in drawing) as shown by a virtual line in FIG. 20, an end part of the lid coupler 75 moves to the upper side of an edge end part 43 of the vessel lid 40 so that the vessel lid 40 is prevented from being separated from the cooking vessel 30, 30′ and cooking is performed in the state.

In addition, in order to separate the vessel lid 40 from the cooking vessel 30, 30′ to open the cooking vessel 30, 30′, when the lid coupler 75 moves in the external direction (right side in drawing) as shown by the solid line in FIG. 20, the end part of the lid coupler 75 blocking the edge end part 43 of the vessel lid 40 moves from the edge end part 43 to the outside so that the vessel lid 40 is separated from the cooking vessel 30, 30′.

As described above, since the ball 78 receiving the elasticity of a spring 77 always presses the lid coupler 75 upwards, the lid coupler 75 is not autonomously moved when external force (hand force) for moving the lid coupler 75 is not received. Accordingly, while cooking is performed in a state in which the vessel lid 40 is attached by the lid coupler 75 to be separated from the cooking vessel 30, 30′, the lid coupler 75 is not autonomously opened, thereby inducing safety cooking.

Although the present disclosure is illustrated and described by drawings, it is not limited thereto and may be modified in various forms by those of skilled in the art to which the present disclosure pertains, and it is obvious that the present disclosure should be broadly protected without departing from the scope of the claims.

According to the present disclosure, a multipurpose induction cooker may perform rice cooking, roasting, and various kinds of cooking, thereby providing effect of performing various kinds of cooking, as well as cooking of various rice, at home with one cooker.

In addition, is provided effect of providing a cooker that is simply operated, rarely fails, and performs rice cooking, roasting, and various kinds of cooking. Moreover, since rice cooking, warm keeping, and various kinds of cooking are possible with one cooker, it is not required to have multiple items for cooking, such as an electric rice cooker, various kinds of cooking vessels, and the like, thereby providing a multipurpose induction cooker capable of maintaining a clean kitchen without causing untidiness.

1. A multipurpose induction cooker, comprising:
an induction heat supply means (10) including a rotary body (11) having a vessel receiving opening (12) formed therein, an L-shape motor support part (13) extended from a lower part of the rotary body (11), an induction coil (16) mounted inside the rotary body (11), and a plurality of guide rollers (17) rotatably disposed on respective roller shafts (17a) that are fixed on an inner circumferential surface of the vessel receiving opening (12) at four positions, respectively;
a support means (20) including a bottom weight part (21) for supporting the rotary body (11), a pair of vertical supports (22) disposed on opposite sides of the bottom weight part (21), respectively, and having rotation center shafts (25, 59) disposed therein to be inserted into body shaft holes (26, 51) formed on opposite sides of the rotary body (11), respectively, and an oil dripping container (24) detachably attached to an oil dripping container receiving groove (23) formed on one side of the bottom weight part (21);
a cooking vessel (30, 30′) configured to be removably received in the vessel receiving opening (12) of the rotary body (11), the cooking vessel (30, 30′) having a cooking chamber (31) foiled therein, and an oil dripping hole (33) formed on one side of a bottom part (34) of the cooking chamber (31);
a vessel lid (40) detachably attached to an upper part of the cooking chamber (31) of the cooking vessel (30, 30′) and having a handle (41) formed therein;
a cooking angle adjustment means (50, 50′) configured to rotate the rotary body (11) supported to the pair of vertical supports (22) to allow the rotary body (11) to be in a tilted or vertical state; and
a vessel driving means (60) configured to transfer power of a reduction motor (61), which is mounted in the motor support part (13) and is operated by a command of a controller (80), to a power transfer plate member (65) locked to a central groove part (35) formed at the center of the bottom part (34) of the cooking vessel (30, 30′).

2. The multipurpose induction cooker of claim 1, wherein one or more long protruding turner rim parts (32) longitudinally protrude from the inner circumferential surface of the cooking vessel (30′) while being integrally formed with the cooking vessel (30′).

3. The multipurpose induction cooker of claim 1, wherein the cooking angle adjustment means (50) comprises:
a left locking protrusion (52) and a right locking protrusion (52′) foiled on opposite sides of a lower part of the body shaft hole (51) of the rotary body (11);
an operation button (55) inserted into a button moving hole (54), which is formed on an outer surface of the vertical support (22) including the rotation center shaft (59) inserted into the body shaft hole (51), to move in a vertical direction;
a coupler penetration groove (53) communicating with the button moving hole (54) and formed on a lower part of the rotation center shaft (59);
a vertical moving device (56) configured to be inserted into the coupler penetration groove (53) to move in a vertical direction, the vertical moving device (56) having an receiving groove (561) formed on an upper part, and a spring rod (562) formed on a lower part, and configured to be connected to an operation button (55) by a coupler (563) penetrating the coupler penetration groove (53);
an elastic member (57) allowing the spring rod (562) to pass through to supply elasticity in an upper direction of the vertical moving device (56); and
a left stopping protrusion (58) and a right stopping protrusion (58′) foiled on an outer circumferential surface of the rotation center shaft (59).

4. The multipurpose induction cooker of claim 1, wherein the cooking angle adjustment means (50′) is configured to allow a plurality of inverted triangular protrusions (503), which protrude at equal intervals from an outer circumferential surface of a power transfer plate (502) fixed to a motor shaft (501a) of a forward and reverse rotation reduction motor (501) disposed inside the vertical support (22) facing the body shaft hole (51), to be matched with and coupled to a plurality of inverted triangular power transfer holes (505) foiled on an outer circumference of the body shaft hole (51) of the rotary body (11).

5. The multipurpose induction cooker of claim 1, wherein the vessel driving means (60) comprises:
a center protrusion (63) and a plurality of rotary protrusions (64) of a power transfer member (62) configured to be rotated by the power of the reduction motor (61), the rotary protrusions (64) protruding on the outside of the center protrusion (63) at equal intervals; and
a center hole (66) and a plurality of locking slots (67) of the power transfer plate member (65) configured to come in surface contact with the power transfer member (62) and be locked to the circumference of the center groove part (35) of the bottom part (34) of the cooking vessel (30, 30′), the locking slots (67) being formed on the outside of the center hole (66) and being configured to allow the rotary protrusions (64) to be inserted thereinto, respectively.

6. The multipurpose induction cooker of claim 1, further comprising a lid receiving means (70) including:
a vessel handle (71) disposed on each of opposite sides of an upper part of the cooking vessel (30, 30′);
a slide groove (73) formed in the vessel handle (71) in a central direction of the cooking vessel (30, 30′) and having separation preventing grooves (72) formed on opposite sides thereof; and a lid coupler (75) configured to be inserted into the slide groove (73) to move in a longitudinal direction and having separation preventing protrusions (74) formed on opposite sides thereof to be inserted into the slide grooves (73), respectively, wherein a ball (78) receiving elasticity of a spring (77), which is inserted into a spring groove (76) formed on a lower part of the middle part of the slide groove (73), is inserted into a ball pressing groove (79) formed on a lower part of the lid coupler (75) to be pressed to the lid coupler (75).
